(19) United States
(12) Patent Application Publication
(10) Pub. No.: US 2021/0352347 A1
(43) Pub. Date: Nov. 11, 2021

(54) ADAPTIVE VIDEO STREAMING SYSTEMS AND METHODS

(71) Applicant: SYNAPTICS INCORPORATED, San Jose, CA (US)

(72) Inventor: Gaurav ARORA, San Jose, CA (US)

(21) Appl. No.: 17/315,147

(22) Filed: May 7, 2021

Related U.S. Application Data
(60) Provisional application No. 63/022,337, filed on May 8, 2020.

(51) Int. Cl. H04N 21/2662; G06N 3/08; H04N 21/24; H04N 21/258; H04L 29/06

(52) U.S. Cl. CPC H04N 21/2662; G06N 3/08; H04L 65/403; H04N 21/25808; H04L 65/601; H04N 21/2402

(57) ABSTRACT

Systems and method for streaming video content include downscaling video content using a downscaling model to generate downscaled video content and downloading the downscaled video content as a video stream and a corresponding upscaling model to a client device. The client device upscales the video stream using the received upscaling model for display by the client device in real-time. A training system trains the downscaling model to generate the downscaled video content, based on associated metadata identifying a type of video content. The downscaled video content and one or more associated upscaling models is stored for access by an edge server, which downloads a plurality of upscaling models to a client device configured to select an upscaling model for use by the client device. Example systems may include video streaming systems and video conferencing systems.

### CROSS-REFERENCE TO RELATED APPLICATIONS

This application claims priority to and the benefit of U.S. Provisional Patent Application No. 63/022,337 filed May 8, 2020, entitled “ADAPTIVE VIDEO STREAMING SYSTEMS AND METHODS”, which is hereby incorporated by reference in its entirety.

### TECHNICAL FIELD

The present disclosure relates generally to streaming audio, video and related content to a client device. More specifically, for example, embodiments of the present disclosure relate to systems and methods for adaptive video streaming to client devices in a content distribution network.

### BACKGROUND

Video streaming services provide on-demand steaming of video, audio and other related content to client devices. In some systems, a content provider makes movies, television shows and other video content available to client subscribers. The client subscribers may operate different devices, from different locations, across a variety of different network connections. Video streaming services thus face a challenge in delivering high quality content to each client subscriber. Another challenge is managing and storing the video content for the different formats needed to serve each client device in an on-demand service platform, particularly as the quantity of video content continues to grow.

In view of the foregoing, there is a continued need in the art for improved content delivery systems and methods that provide high quality, on-demand content to various clients, while making efficient use of content provider and network resources.

### SUMMARY

In various embodiments, systems and methods for distributing media content to a plurality of client devices including downscaling video content using a downscaling model to generate downscaled video content and downloading the downscaled video content as a video stream and a corresponding upscaling model to a client device. The client device is configured to upscale the video stream using the downloaded upscaling model for display by the client device. The method may further include training the downscaling model to generate the downscaled video content, by training a neural network model using a training dataset comprising video content and associated type information.

In some embodiments, the video content includes associated metadata identifying a type of video content, and the downscaling model is trained to generate the downscaled video content for the type of video content. The downscaled video content and one or more associated upscaling models is stored with the media content by an edge server. The edge server is configured to download the downscaled video content as a video stream along with the corresponding upscaling model to a client device. In some embodiments, the edge server downloads a plurality of upscaling models to the client device, the client device is configured to select an upscaling model for use by the client device. The method may be performed by a variety of video streaming systems, including video conference systems.

In some embodiments, the method includes receiving a request from the client device for the video content, detecting a network bandwidth, and selecting the downscaling model based on the detected network bandwidth. The method may further include receiving a request from the client device for the video content, determining a client device configuration, and selecting the upscaling model based on the determined client device configuration.

In various embodiments, a system comprising for streaming video content includes an edge content storage configured to store video content and corresponding scaling models, and an edge server configured to receive an instruction to stream selected stored video content to a client device and stream the selected stored video content and at least one corresponding scaling model to the client device.

The system may further include a host system configured to downscale video content using a downscaling model to generate downscaled video content and download the downscaled video content and a corresponding upscaling model to the edge server. The host system may further include an upscaling model training system configured to detect a video content type and train the scale model to optimize upscaling of video for the video content type. The host system further includes a downscaling model training system configured to train a downscale model to receive video content and generate downscaled video content for streaming.

The system may further include a client device configured to receive the selected stored video content including the at least one corresponding scaling model, decode the received video content, upscale the decoded video content using one of the at least one corresponding scaling model, and stream the upscaled video content to a media player for display.

The scope of the disclosure is defined by the claims, which are incorporated into this section by reference. A more complete understanding of the disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

Aspects of the disclosure and their advantages can be better understood with reference to the following drawings and the detailed description that follows. It should be appreciated that like reference numerals are used to identify like elements illustrated in one or more of the figures, wherein showings therein are for purposes of illustrating embodiments of the present disclosure and not for purposes of limiting the same. The components in the drawings are not necessarily to scale, emphasis instead being placed upon clearly illustrating the principles of the present disclosure.

FIG. 1 is a diagram illustrating a content delivery system, in accordance with one or more embodiments.

FIG. 2 illustrates example media server components that may be implemented in one or more physical devices of a content delivery system, in accordance with one or more embodiments.

FIG. 3 illustrates client device components that may be implemented in one or more physical devices, in accordance with one or more embodiments.

FIG. 4 illustrates an example operation of a content delivery system, in accordance with one or more embodiments.

FIG. 5 illustrates an example video conferencing system, in accordance with one or more embodiments.

FIG. 6 illustrates an example artificial intelligence training system, in accordance with one or more embodiments.

FIG. 7 illustrates an example process for operating a content distribution network, in accordance with one or more embodiments.

### DETAILED DESCRIPTION

Various embodiments of systems and methods for adaptively streaming video content using artificial intelligence are disclosed herein.

Conventional video streaming services typically deliver video content to client devices over Internet Protocol (IP) networks. To accommodate various client devices, network speeds, and client device locations, video streaming services often use a protocol known as adaptive bitrate streaming, which works by detecting a client's network bandwidth and device processing capacity and adjusting the quality of the media stream accordingly in real-time.

In some embodiments, adaptive bitrate streaming is performed using an encoder which can encode a single media source (e.g video or audio) into various streams at multiple bit rates, with each stream divided into a sequence of “chunks” (e.g., 1-2 second blocks) for delivery to the streaming client device. It is often desirable to provide the client device with video at a resolution that is optimized for the resources of the network and client device. For example, different client devices may have different screen resolutions and the delivered content may be optimized to deliver a video stream to each client device at its maximum screen resolution (e.g., a 4K TV could request a 2160p stream, a full high definition TV could request a 1080p stream and a mobile phone may request a 720p stream).

The network bandwidth also provides a constraint on streaming quality. For example, if the client device receives the video for a 4K TV via a network having bandwidth of 20-30 Mbps (which facilitates 4K streaming) a high-quality video may be displayed. However, if the network bandwidth drops (e.g., to 10 Mbps due to network congestion), then the client device may detect that it is not receiving the video chunks on time and request a lower resolution (e.g, 1080p version) of the stream for the next chunk. When the bandwidth goes back up, the client can pull the next chunk from the 4K stream. In some embodiments, lower resolution image chunks (e.g., 1080p) may be received by the client device, decoded and upscaled with hardware upscalers (e.g., using bicubic interpolation) inside the client device (e.g., a television, set-top box, mobile/tablet, system on a Chip (SoC), etc.) to match an optimal resolution for the display.

In various embodiments of the present disclosure, the network includes one or more content delivery servers, edge servers and/or other devices that are configured with neural network accelerators including an artificial intelligence processor architecture including a fully programmable vector unit (VPU) and specialized processing engines for pooling convolutional and fully connected neural networks layers. The neural network accelerator may be embedded within a video SoC, which also includes a video scaling engine (e.g., upscaler and/or downscaler). The upscaling techniques disclosed herein are superior to conventional hardware scalers in that they can give a better perceptual quality and a neural network model can be trained to a particular type of content (e.g., movie drama, action movie, sporting event, etc.). In some embodiments, the neural network model operates as a trainable filter and it can outperform hardware scalers, for example, around sharpening high frequency areas like edges.

In some embodiments, the use of artificial intelligence-based resolution scalers allows the content distribution system to reduce the number of streams stored at different resolutions on the encoding server side, thereby reducing storage costs. In one embodiment, a single stream is stored and provided to various client devices along with a resolution scaling model to upscale the stream to the desired screen resolution. The neural network model may be a fraction of the size of the video stream. For example, the neural network model to upscale from 1080p to 2160p may comprise a 5 MB download, while a stream for a full-length movie (90 min long) maybe approximately 6750 MB, saving 6 GB of storage and associated network bandwidth.

In various embodiments, the content delivery system may define a plurality of scaling models for delivery to client devices. For example, if the content stream is 720p resolution then the system could have an upscaling model for upscaling the video content to 1080p and another upscaling model for upscaling the video content to 2160p. The systems and methods disclosed herein provide good quality upscaled video on the client device without having the content server overhead of storing and switching multiple streams to adapt to the available network bandwidth. The content server may be configured to download the neural network scaling models at the beginning of a streaming session, which may be trained for the particular type of content being streamed, such as drama, fast paced action, sports, etc.

The present disclosure provides numerous advantages over conventional content delivery systems. For example, hardware scalers can perform upscaling of a single stream, but the end quality is not as good (e.g., because the fixed model is not adapted to the content). In the present disclosure, neural network scaling provides improved picture quality and the ability to adjust the scaling to suit the content being upscaled. It has been observed that the embodiments disclosed herein can improve peak-signal-to-noise-ratio (PSNR) over conventional bicubic interpolation approaches by 4 or more decibels (DB), resulting in improve perceptual image quality to the human eye.

Convention systems also require storage of multiple versions of the video content for various resolutions (e.g., 1080P, 4 k, etc.) and bandwidths. In many systems, the content server and client device exchange messages to determine which content to stream based on, for example, the current network bandwidth capacity and client device processing and display capabilities. Further benefits of the present disclosure include reduced storage cost at the content server or in the cloud, reduced complexity of client-side streaming software, reduced need for performance tracking and messaging, and reduced latency because the client no longer needs to determine which resolution stream to play. The embodiments of the present disclosure can also be used to improve picture quality in locations where streaming infrastructure is limited.

The systems and methods disclosed herein may also be used with other video streaming applications, such as a video conferencing application. The network challenges on video calls includes both downstream bandwidth limitations and upstream bandwidth limitations. A video session may include neural network resolution scalers on each client device on the call. For example, a video captured in real-time at 360p or 480p can be upscaled to 1080p using the neural network scalers disclosure herein to provide each participant with a higher perceived video quality.

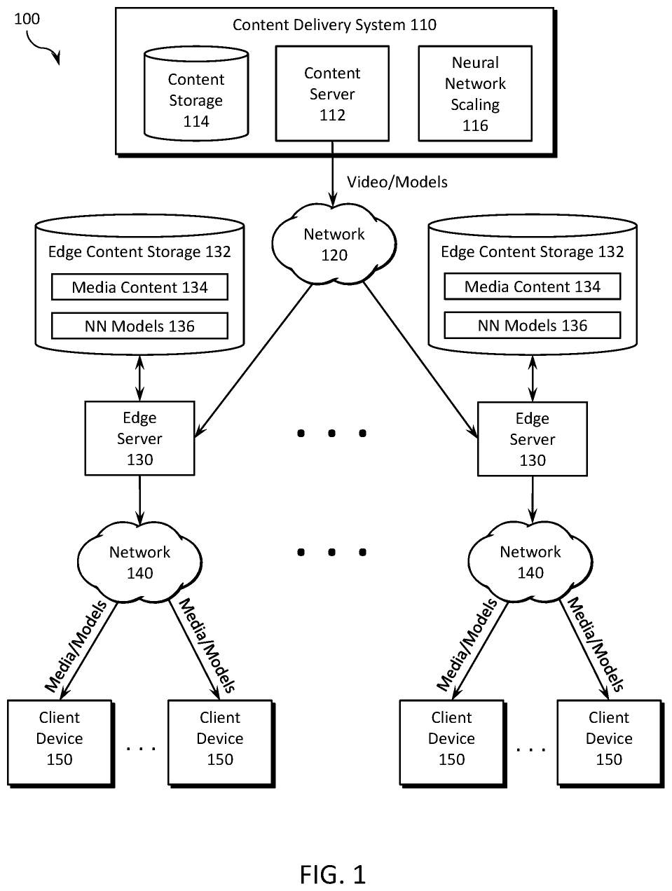

Referring to FIG. 1, an example content distribution network 100 will now be described in accordance with one or more embodiments of the present disclosure. In the illustrated embodiment, the content distribution network 100 includes a content delivery system 110 including one or more content servers 112, one or more edge servers 130, and one or more client devices 150.

The content delivery system 110 further includes content storage 114 for storing video content (and other related content, as desired) for distribution by the content distribution network 100, and neural network scaling components 116 for training scaling neural networks use by the content distribution network 100. The content server 112 is communicably coupled to the edge servers 130 over a network 120, Which may include one or more wired and/or wireless communication networks. The content delivery system 110 is configured to store video content, including audio data, video data and other media data, in content storage 114, which may include one or more databases, storage devices and/or storage networks.

The edge servers 130 are configured to receive media content and neural network scaling models from the content server 112 and stream the media content and deliver the neural network scaling models to each client device 150. The edge servers 130 may be geographically distributed to provide media services to regional client devices 150 across regional networks 140. The client devices 150 may access content on any number edge servers 130 connected through one or more of the networks 120 and 140.

FIG. 1 illustrates one example embodiment of a content delivery network. Other embodiments may include more elements, less elements and/or different elements and various components described herein may be distributed across multiple devices and/or networks, and/or combined into one or more devices as desired.

In operation, the content delivery system 110 receives media content and encodes the media content for delivery to client devices. The encoding process may include training one or more neural networks to scale the media content, allowing for a single media file to be delivered to a client device along with trained neural network scaling models. In some embodiments, upscale neural network models and downscale neural network models may be trained to accommodate different communications bandwidths, processing resources and display resolutions associated with various client devices 150. The encoded media content and associated neural network models are then distributed to one or more edge servers 130 for delivery to client devices.

Each client device 150 includes or is connected to a display and, in some implementations, audio output resources. A user may access an application on the client device 150 to select and stream media content 134 available for streaming from an edge server 130. The client device 150 receives the neural network models 136 associated with the media content and a stream of media content. In the illustrated embodiment, an edge content storage system 132 stores the media content 134 and the neural network models 136 for access by the edge server 130. The client device is configured to decode streamed media content, scale the media content using a selected scaling neural network and deliver the decoded and scaled media content to the display and audio output resources. In some embodiments, the media file is downloaded and stored on the client device for playback at a later time, and the decoding and scaling operations may be performed during playback.

In various embodiments, the client device 150 may include a personal computer, laptop computer, tablet computer, mobile device, a video display system, or other device configured to receive and play media content from an edge server 130 as described herein.

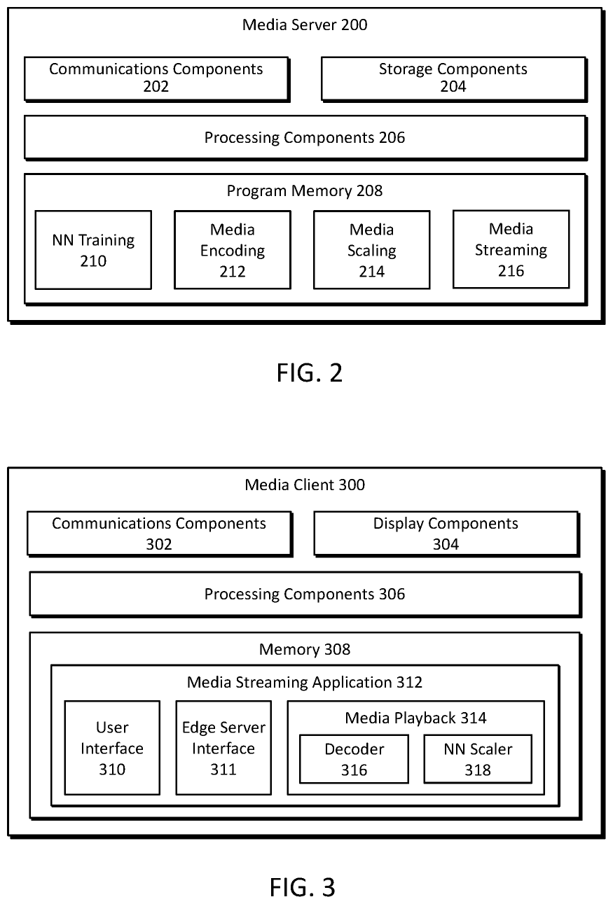

FIG. 2 illustrates example media server components that may be implemented in one or more physical devices of a content delivery network, in accordance with one or more embodiments. As illustrated, media server 200 includes communications components 202, storage components 204, processing components 206 and program memory 208. The media server 200 may represent any type network video server configured to perform some or all of the processing steps disclosed herein. The components illustrated in FIG. 2 may be implemented as a standalone server, may be distributed among a plurality of different devices, and/or may include additional components.

Processing components 206 may be implemented as any appropriate processing device (e.g., logic device, microcontroller, processor, application specific integrated circuit (ASIC), a field programmable gate array (FPGA), or other device) that may be used by media server 200 to execute appropriate instructions, such as software instructions stored in program memory 208, which include neural network training components 210, media encoding components 212, media scaling components 214, and media streaming components 216.

The program memory 208 may include one or more memory devices (e.g., memory components) that store data and information, including image data (e.g., including thermal imaging data), audio data, network information, camera information, and/or other types of sensor data, and/or other monitoring information. The memory devices may include various types of memory for information storage including volatile and non-volatile memory devices, such as RAM (Random Access Memory), ROM (Read-Only Memory), EEPROM (Electrically-Erasable Read-Only Memory), flash memory, a disk drive, and other types of memory. In some embodiments, processing components 206 are configured to execute software instructions stored in program memory 208 to perform various methods, processes, or operations described herein. Storage components 204 may comprise memory components and mass storage devices such as storage area network, cloud storage, or other storage components configured to store media content and neural network information.

Communications components 202 may include circuitry or other components for communicating with other devices using one or more communications protocols. For example, communications components 202 may include wireless and/or wireless communications components such as components that generate, receive, and/or process communications signals over one or more networks such as a cellular network, the Internet, or other communications network. The communications components 202 may be used to receive media content for streaming to one or more client devices. The media content may include video streams and files that are compressed such as with industry standard video compression formats which may include MPEG-2, MPEG-4, H.263, H.264, high efficiency video coding, AV1, and MJPEG standards to reduce network bandwidth, use of image processing resources, and storage.

Referring to FIG. 3, example components of a media client 300 will now be described, in accordance with one or more embodiments of the present disclosure. The media client 300 is configured to access the media server 200 across a network to receive and process a stream of media content. The media client 300 includes communications components 302, display components 304, processing components 306, memory components 308, and/or other components. The processing components 306 may include logic devices, microcontrollers, processors, ASICs, FPGAs, or other devices that may be used by media client 300 to execute appropriate instructions, such as software instructions stored in memory 308.

The media client 300 is configured to execute a media streaming application 312 stored in the memory 308. The media streaming application 312 may include a user interface 310 allowing a user to interface with the media server and select media for playback on the media client 300, an edge server interface 311 configured to facilitate communications between the media client 300 and a media server 200, and media playback modules 314 configured to receive the streamed media content and prepare the media for output on the display components 304 (e.g., a television, a computer monitor with speakers, a mobile phone, etc.). The media playback module 314 may include a decoder 316 for decoding and uncompressing the received video stream and a neural network scaler 318 configured to upscale the received media content for playback on the media client 300.

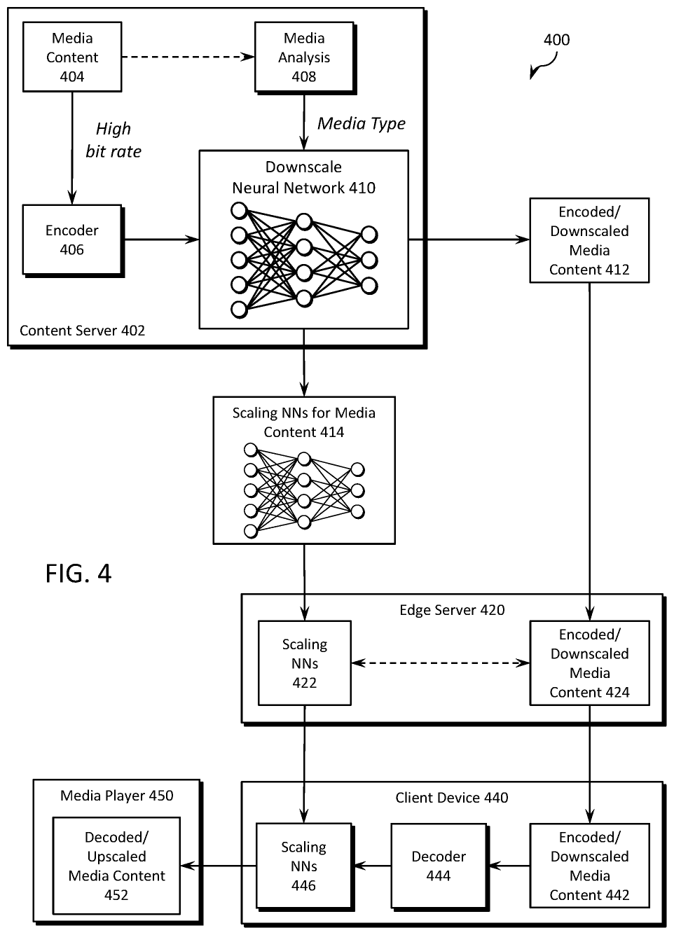

FIG. 4 illustrates an example operation of a content delivery system, in accordance with one or more embodiments. A content delivery process 400 starts at the content server 402 with preparation of media content 404 (e.g., a movie) for streaming. The media content 404 is compressed and encoded by encoder 406 into a video file format supported by the system to reduce file size for streaming. The media content 404 is also analyzed by a media analysis component 408 to determine a type of media for use in further processing. Media types may include drama, action movie, sporting event, and/or other media types as appropriate.

The media content is then downscaled using a downscale neural network 410 corresponding to the identified media type. The content server 402 provides the encoded/downsampled media content 412 and scaling neural networks 414 to the edge server 420 for streaming to one or more clients, such as client device 440. The edge server 420 receives a request for the media content from the client device 440 and transmits the associated encoded/downsampled media content 424 and corresponding scaling neural network 422 to the client device 440. The client device 440 receives the encoded/downsampled media content 442, decodes the media content using decoder 444, and applies an appropriate scaling neural network 446 to generate a high-resolution version of the media content 452 for playback on a media player 450.

The systems and methods described herein reduce bandwidth requirements for delivering the media content. In some embodiments, a single encoded/downscaled media content 412 is generated and delivered to a client device 440 along with one or more scaling neural networks 446 to upscale the delivered media content on the client device 440. In some embodiments, the client device 440 monitors the media stream to determine whether there is sufficient bandwidth to process the streaming media content, and notifies the edge server 420 to downsample the encoded/downscaled media content 424 before delivery to the client device 440 to enable the system to further adapt the content for use on equipment that cannot efficiently handle the size of the encoded and downsampled media content.

In various embodiments, the resolution of the encoded/downscaled media content 424 is selected to optimize video quality using available bandwidth between the edge server 420 and client device 440. In some cases, however, the bandwidth may be reduced/degraded at various times (e.g., higher than normal network traffic, network or device failures or maintenance, etc.). To accommodate low bandwidth scenarios, the scaling neural networks 422 may further include downscaling neural networks and correspondence upscaling neural networks. For example, the edge server 420 and/or client device 440 detecting a low bandwidth scenario may produce an instruction for the edge server 420 to downscale the media content 424 using a scaling neural network 422 before streaming to the client device, and the client device will receive and apply the appropriate upscaling neural networks 446. In one implementation, it may be sufficient to configure the edge server 420 with three upscalers (e.g., to handle four output resolutions) and one downscaler/upscaler pair to provide additional flexibility for low bandwidth scenarios.

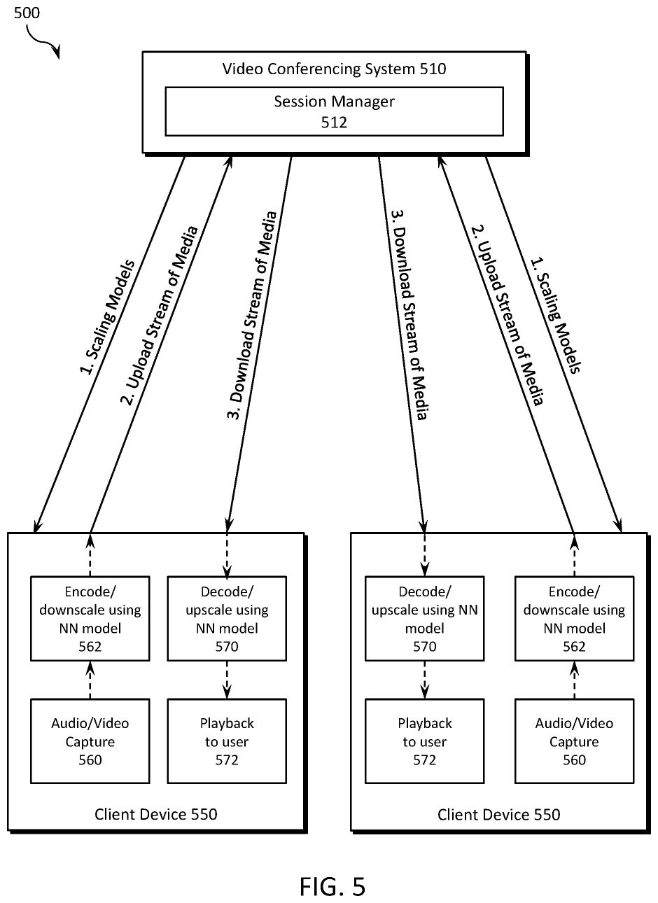

A person skilled in the art will recognize that the systems and methods disclosed herein are not limited to an on-demand media content streaming service and may be applied to other applications where streaming media is used. For example, referring to FIG. 5, a content distribution system 500 includes a video conferencing system 510 that uses scaling neural networks for communicating between two or more client devices 550. The illustrated embodiment shows a hosted VoIP system, but it will be appreciated that other video conferencing configurations, including peer-to-peer communications, may also be used.

The video conferencing system 510 includes a session manager for managing communications between client devices 550. In one embodiment, the session manager 512 distributes scaling neural networking models for use by a client for both incoming and outgoing communications. The client device 550, may capture audio and video 560 from a user and encode/downscale the media using a downscale neural network model 562 to reduce bandwidth requirements for the uploaded stream of media. At the same time, the client device 550 may receive a downloaded stream of media from other client devices 550 via the session manager 512. The client device decodes and upscales the downloaded media using an upscale neural network 570 and outputs the media for the user 572.

In various embodiments, the client device 550 may be configured to capture the camera stream at a resolution that both end points have determined to be optimal for the conditions, thereby avoiding the need to downscale the stream before transmission. For example, both end points can determine that they can stream at 720p and let the respective artificial intelligence (AI) upscaling models scale the streams to 4K. In other embodiments, peer-to-peer communications may be established without use of an intermediary session manager, for example, by using an application and/or protocol that determines the video resolution for streaming and predetermined upscaling neural network models for processing the incoming video stream(s). It will be appreciated that the video conferencing system may be used with more than two client devices in both the hosted and peer-to-peer implementations.

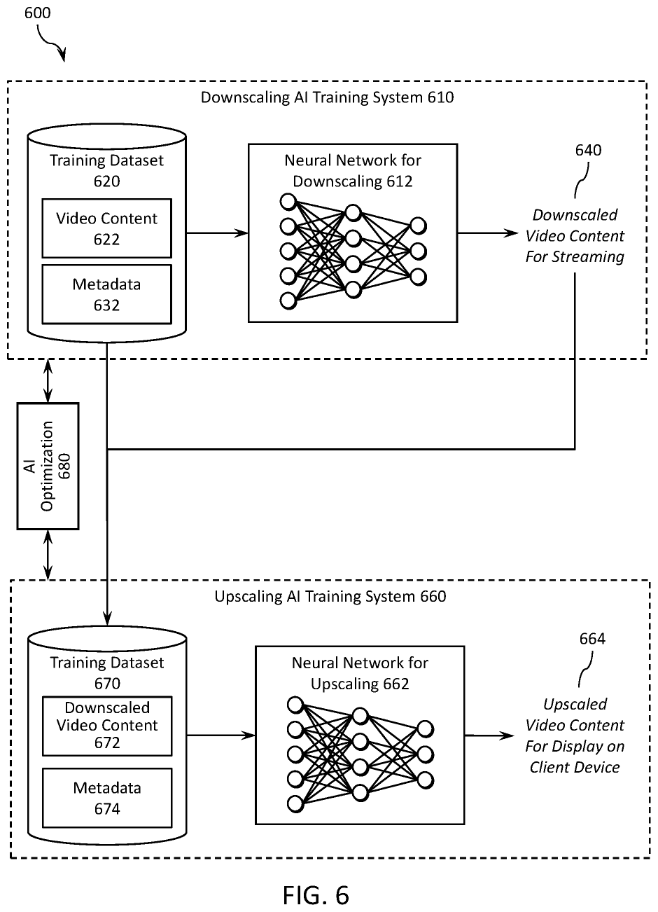

Referring to FIG. 6, an example artificial intelligence training system 600 will now be described, in accordance with one or more embodiments. In various embodiments, the training system 600 includes a downscaling artificial intelligence training system 610, configured to train one or more AIs to downscale original video content for storage and streaming, and an upscaling AI training system 660, configured to train one or more AIs for use by a client device to upscale the downscaled video content.

In some embodiments, the AIs include neural networks, including neural network 612 for downscaling, and a neural network 662 for upscaling. For example, the neural networks may include one or more convolutional neural networks (CNN) that receives a training dataset (such as training dataset 620 including video content 622 and metadata 632, and training dataset 670 including downscaled video content 672 and metadata 674) and outputs scaled video content.

The training dataset 620 may include original video content 622 and metadata 632 identifying a type of video content (e.g., action movie, drama, sporting event, etc.). In some embodiments, a plurality of neural networks 612 are trained for each of a plurality of different types of video content to optimize the scaling for the content. In one embodiment, training starts with a forward pass through the neural network 612 including feature extraction, a plurality of convolution layers and pooling layers, a plurality of fully connected layers, and an output layer that includes the desired classification. Next, a backward pass through the neural network 612 may be used to update the CNN parameters in view of errors produced in the forward pass (e.g., to reduce scaling errors and/or improve image quality of the downscaled video content 640). In various embodiments, other processes may be used to train the AI system in accordance with the present disclosure.

The training dataset 670 may include the downscaled video content 672 and metadata 674 identifying a type of video content (e.g., action movie, drama, sporting event). In some embodiments, a plurality of neural networks 662 are trained for each of a plurality of different types of video content and desired output resolutions to optimize the scaling for the content. In one embodiment, training starts with a forward pass through the neural network 662 including feature extraction, a plurality of convolution layers and pooling layers, a plurality of fully connected layers, and an output layer that includes the desired classification. Next, a backward pass through the neural network 662 may be used to update the CNN parameters in view of errors produced in the forward pass (e.g., to reduce scaling errors and/or improve image quality of the upscaled video content 664 compared to the original video content).

In various embodiments, other processes may be used to train the AI system in accordance with the present disclosure. For example, a validation process may include running a test dataset through the trained neural networks and validating that the output image quality (e.g., as measured by PSNR) meets or exceeds a desired threshold. In another example, detected errors from the downscaling AI training system 610, the upscaling AI training system 660, and the validation process may be analyzed and fed back to the training systems through an AI optimization process 680 to optimize the training models, for example, by comparing the accuracy of different AI models and selecting training data, and model parameters that optimize the quality of the scaled images.

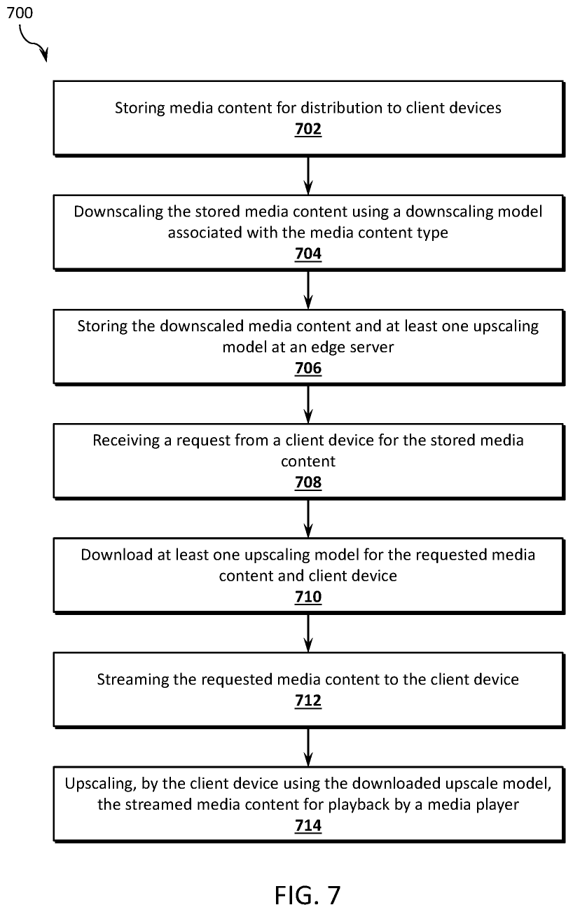

Referring to FIG. 7, a process for operating a content distribution network, such as the systems described in FIGS. 1-6 herein, will now be described in accordance with one or more embodiments. A process 700 includes storing media content (e.g. video, audio, etc.) for distribution to client devices across a content distribution network, at step 702. In step 704, the stored media content is downscaled using a downscaling model selected based on a determined media content type. In some embodiments, the downscaling model is a neural network model trained to optimize media content of the determined type for distribution. In some embodiments, the upscaling model is a neural network model trained to upscale media content generated by a corresponding downscaling model. A plurality of upscaling models may be trained to accommodate different displays, resolutions, and processing capabilities of the client device.

In step 706, the downscaled media content and at least one upscaling model are stored at an edge server for distribution to one or more client device. In some embodiments, a second downscaling model may be stored with the media content to further downscale the media content for distribution in a low bandwidth scenario.

In step 708, the process receives a request from a client device for the stored media content. In step 710, the edge server downloads at least one upscaling model for the requested media content and client device. In step 712, the edge device streams the media content to the client, where it is upscaled in step 714, using the downloaded upscale model, for playback by a media player.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure.

Various embodiments provided herein can be implemented using hardware, software, or combinations of hardware and software, and various hardware and software components can be combined into one or more components comprising a combination of software and/or hardware, without departing from the spirit of the present disclosure. Where applicable, the ordering of various steps described herein can be changed, combined into composite steps, and/or separated into sub-steps to provide features described herein.

Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for streaming video content comprising:
downscaling video content using a downscaling model to generate downscaled video content; and
downloading the downscaled video content as a video stream and a corresponding upscaling model to a client device;
wherein the client device is configured to upscale the video stream using the downloaded upscaling model for display by the client device.

2. The method of claim 1, further comprising training the downscaling model to generate the downscaled video content.

3. The method of claim 1, wherein training the downscaling model further comprises training a neural network model using a training dataset comprising video content and associated type information.

4. The method of claim 1, wherein the video content includes associated metadata identifying a type of video content, and wherein the downscaling model is trained to generate the downscaled video content for the type of video content.

5. The method of claim 1, wherein the downscaled video content and one or more associated upscaling models is stored for access by an edge server.

6. The method of claim 5, wherein downloading the downscaled video content as the video stream and the corresponding upscaling model is performed by the edge server.

7. The method of claim 6, wherein the edge server downloads a plurality of upscaling models to the client device; and wherein the client device is configured to select an upscaling model for use by the client device.

8. The method of claim 1, wherein the method is performed by a video streaming system.

9. The method of claim 1, further comprising initiating a video conferencing session.

10. The method of claim 1, further comprising:
receiving a request from the client device for the video content;
detecting a network bandwidth; and
selecting the downscaling model based on the detected network bandwidth.

11. The method of claim 1, further comprising:
receiving a request from the client device for the video content;
determining a client device configuration; and
selecting the upscaling model based on the determined client device configuration.

12. A system comprising:
an edge content storage configured to store video content and corresponding scaling models; and
an edge server configured to receive an instruction to stream selected stored video content to a client device and stream the selected stored video content and at least one corresponding scaling model to the client device.

13. The system of claim 12, further comprising a host system configured to downscale video content using a downscaling model to generate downscaled video content and downloading the downscaled video content and a corresponding upscaling model to the edge server.

14. The system of claim 13, wherein the host system comprises an upscaling model training system configured to generate the scale model.

15. The system of claim 14, wherein the upscaling model training system is configured to detect a video content type and train the scale model to optimize upscaling of video for the video content type.

16. The system of claim 14, wherein the host system further comprises a downscaling model training system configured to train a downscale model to receive video content and generate downscaled video content for streaming.

17. The system of claim 12, wherein the video content includes associated metadata identifying a type of video content, and wherein the downscaling model is trained to generate the downscaled video content for the type of video content.

18. The system of claim 12, wherein the edge server is configured to download a plurality of upscaling models to the client device; and wherein the client device is configured to select an upscaling model for use by the client device in preparing the video stream for display.

19. The system of claim 12, wherein the system is a video streaming system and/or a video conferencing system.

20. The system of claim 12, further comprising the client device, wherein the client device is configured to:
receive the selected stored video content including the at least one corresponding scaling model;
decode the received video content;
upscale the decoded video content using one of the at least one corresponding scaling model; and
stream the upscaled video content to a media player for display.
